(19) United States
(12) Patent Application Publication
(10) Pub. No.: US 2005/0122527 A1
(43) Pub. Date: Jun. 9, 2005

(54) Method and device for microscopicdisplay with local probes of a three-dimensional object

(76) Inventors: Albert-Claude Boccara, Paris (FR); Arnaud Dubois, Les Ulis (FR)

Correspondence Address: YOUNG & THOMPSON, 745 SOUTH 23RD STREET, 2ND FLOOR, ARLINGTON, VA, 22202, US

(21) Appl. No.: 10/500,876

(22) PCT Filed: Jan. 7, 2003
(86) PCT No.: PCT/FR03/00029

(30) Foreign Application Priority Data
Jan. 7, 2002 (FR) 02/00132

(51) Int. Cl. G01B 9/02

(52) U.S. Cl. 356/450

(57) ABSTRACT

A method for microscopic display of a three-dimensional object wherein the sample (1) is displayed through an interferometer (2). Local probes (9) of nanometric dimensions are introduced in the sample (1). The device for microscopic display of a three-dimensional object includes an interferometer (2), a wide-spectrum source (5), a matrix sensor (6), elements for forming the image of a thin edge of the object on the sensor through the interferometer (2), a unit for processing the image produced by the matrix sensor (6). The device includes elements for inserting local probes in the sample.

The present invention relates to a method and a device of microscopic visualization of a three-dimensional object.

Nearfield microscopy techniques (STM—Scanning Tunneling Microscopy; AFM—Atomic Force Microscopy; SNOM—Scanning Nearfield Optical Microscopy ) whereof the principle consists in scanning a peak at the surface of the sample, enabling to obtain pictures with a resolution higher than that of the conventional optical microscopy.

These techniques have developed rapidly over the last years, but are only applicable to the survey of surfaces.

The aim of the present invention is the realization of three-dimensional pictures thereby enabling visualization of the inside of a sample with a definition also higher than that permitted by the conventional optical microscopy.

Such a three-dimensional visualization offering nanometric resolution may receive numerous applications.

Generally speaking, it enables to track local probes included in structures.

In certain cases, this visualization consists of the representation of a slice, limited in depth, of the sample. In other cases, the accumulation of the pieces of information contained in several slices enables to obtain global three-dimensional visualizations, for example in perspective.

Different applications of this visualization of local probes are possible.

The probes may be animated with limited movements within a structure.

The analysis of the positions of the probes, of their statistic distribution, enables to acquire knowledge on the structure, for instance on walls limiting the movements of the probes.

Thus, the method and device of visualization subject of the present invention enable to realise detailed pictures of the interstitial volume.

This method still enables exploration of the structure of physiological elements such as cells like the neurones, to describe the contact between two solid grains and to follow their evolution, to follow the dynamic diffusion of elements in a soft matter or still to perform temperature measurements of complex structures such as power electronic components.

When the probes are fixed, the study of their positions and of the possible evolution of these positions enables better to know the medium wherein they are fixed and the external possible parameters to which they are subjected.

In particular, it may be applied to the visualization of a colloidal gel whereof it will be possible to acquire accurate knowledge of the behaviour, for instance when it is subjected to homogeneous deformation.

One may thus study the structure of flocculated silica suspension. Indeed, by flocculation then concentration, it is possible to realise very regular and little dense silica aggregates, composed of spheres of approximately 50 nm in diameter.

To that end, the invention relates to a method of microscopic visualization of a three-dimensional object wherein the sample is visualised through an interferometer.

According to the invention, local probes of nanometric dimensions are inserted in the sample.

The probes are quite numerous, they are generally from 100 to several thousands in the observed field.

It has been seen that these local probes or particles may be animated by a movement whereof the time-related analysis enables the realization of characteristic pictures of the object. This movement may be the Brownian movement or it may be generated by acting on the probes, for instance by magnetic or electric effect.

The probes are of nanometric dimensions, i.e. generally smaller than 200 nanometers. They should diffuse the light. Thus, metallic probes sending back a significant proportion of the light that they receive in the opposite direction give good results.

In different preferred embodiments each exhibiting their specific advantages and liable to be combined together:

the local probes are balls,

the local probes are metallic,

the interferometer is a Michelson interferometer,

the interferometer is a Linnik interferometer,

the interferometer is a Mirau interferometer,

the interferometer includes a wide spectrum source,

By ‘wide spectrum source’ is meant here a source having a coherence length of the order of a micrometer.

the source delivers short light pulses,

optical means form the picture of a thin slice of the object on a matrix detector via the interferometer.

The thickness of the slice visualised is of the order of the coherence length of the source.

The invention also relates to a device of microscopic visualization of a three-dimensional object including:

an interferometer,

a wide spectrum source,

a matrix sensor,

means to form the picture of a thin slice of the object on the sensor via the interferometer,

a unit for processing the picture produced by the matrix sensor.

According to the invention, the device includes means for inserting local probes in the sample.

The light source is advantageously a pulse source which enables to fix the possible movement of the probes.

A particular embodiment of the invention will be described in detail with reference to the appended drawings wherein:

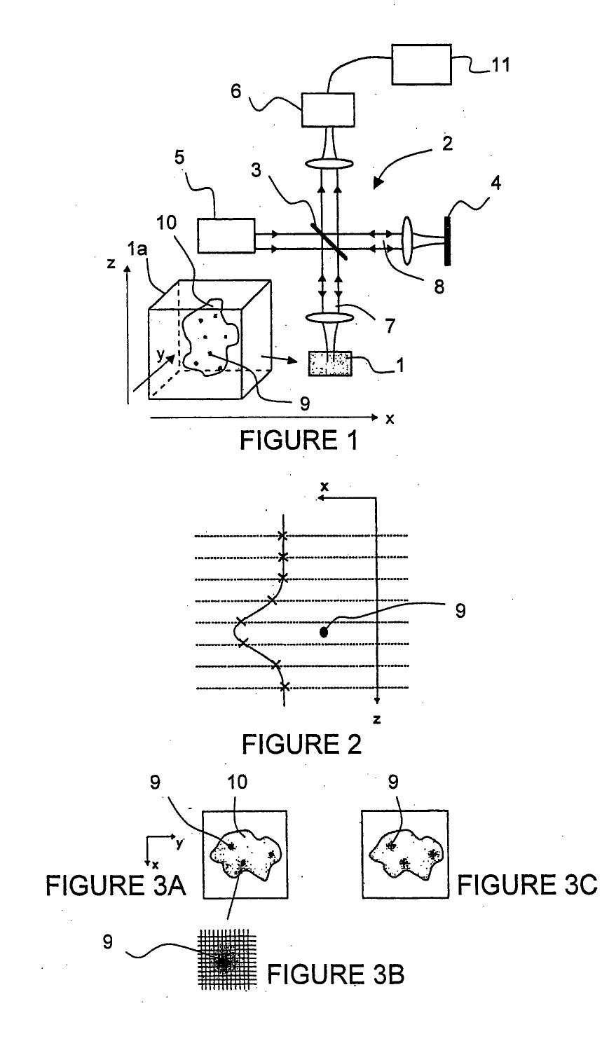

FIG. 1 is a representation of the device of the invention;

FIG. 2 is a representation of the distribution of the energy received enabling localisation of a depth probe;

FIG. 3 is a schematic representation enabling to specify lateral localisation of the probes.

On FIG. 1, the sample has been represented in perspective and designated under the reference la with respect to the co-ordinates x, y, z then a side view of the reference 1 with respect to the plane xz.

The interferometer 2 is a Michelson interferometer composed of a semi-transparent blade 3, of a reference mirror 4, of a light source 5 and of a two-dimensional sensor 6 defining two bras: the measurement arm 7 and the reference arm 8.

According to the invention, the local probes 9 or balls are inserted in the sample. They are particles of nanometric dimensions whereof the average dimension is smaller than 200 nm, preferably ranging between 20 and 200 nm.

These probes are numerous, generally several thousands and at least one hundred in the field observed.

The voxel being the volume unit of the resoluted object, one obtains good results when the probes are sufficient in number to be distributed in the volume observed, but sufficiently low so that, generally, one probe at most is present in a voxel.

The probes are in a medium such a liquid, a gas or a gel. This medium must be transparent to observation wavelengths.

These probes 9 are preferably metallic balls, advantageously of gold or of silver.

They are animated by a Brownian movement while remaining inside a volume 10.

The light source 5 is advantageously a wide pulse source. The coherence width or length of the source determines, among others, the depth resolution. A pulse source enables to fix the possible movement of the probes 9.

The device thus enables to acquire, at a given instant, the position of each of the probes inside the sample.

Indeed, the picture received by the two-dimensional sensor 6, preferably a CCD camera (Charge Coupled Device) or CMOS, provides for each probe a picture whereof the positioning in the plane xy of the sensor 6 is represented on FIGS. 3, 3B and 3C. To this day, sensors having 1000×1000 pixels are common.

FIG. 3 represents the pictures of each of the probes with respect to the contour 10 of the sample, FIG. 3B is an enlarged representation of one of these pictures whereof the central position is obtained by processing and then positioned in the plane xy as represented on FIG. 3C.

The definition obtained in the plane xy depends on the definition of the sensor 6 and on the digital processing carried by the processing unit 11 to obtain the central position of each of the probes.

The depth positioning is obtained by interferometric techniques and represented on FIG. 2. The depth measurement field is determined by the coherence length of the light 5 which is advantageously low.

This field depth is itself divisible by analysis of the phase, each of the probes 9 producing a picture of different colour according to its position inside the field. Besides, it is possible to vary the relative positions of the sample and of the reference mirror, thereby modifying the position of the field, in depth, inside the sample.

It is therefore thus possible to obtain at each instant the three-dimensional visualization of the probes inside the sample. The accumulation of these pieces of information varying due to the Brownian movement to which the probes are subjected, enables to obtain via the processing unit, the three-dimensional contour 10 of the sample.

The field depth is conventionally of the order of 1 micron and one obtains, by analysis of the phase, space localisation of the probes with a resolution of the order of some ten nanometers in each direction. Similarly, the sampling of diffraction spots enables localisation of their centres, which are characteristic of the positions of the probes with enhanced accuracy. The interferometric techniques involve enable visualization of probes of a few ten nanometers in diameter which exhibit the equivalent of a reflection coefficient of approximately 10⁻⁵ for visible wavelengths.

Different types of interferometer may be used whereas the description made above implements a Michelson interferometer, it is also possible to use a Linnik interferometer or a Mirau interferometer.

1. A method of microscopic visualization of a three-dimensional object wherein the sample (1) is visualized through an interferometer (2),
characterized in that local probes (9) of nanometric dimensions are inserted in the sample (1).

2. A method of microscopic visualization of a three-dimensional object according to claim 1, characterized in that the local probes (9) are balls.

3. A method of microscopic visualization of a three-dimensional object according to claim 1, characterized in that the local probes (9) are metallic.

4. A method of microscopic visualization of a three-dimensional object according to claim 1, characterized in that the interferometer (2) is a Michelson interferometer.

5. A method of microscopic visualization of a three-dimensional object according to claim 1, characterized in that the interferometer (2) is a Linnik interferometer.

6. A method of microscopic visualization of a three-dimensional object according to claim 1, characterized in that the interferometer (2) is a Mirau interferometer.

7. A method of microscopic visualization of a three-dimensional object according to claim 4, characterized in that the interferometer (2) includes a wide spectrum source (5).

8. A method of microscopic visualization of a three-dimensional object according to claim 7, characterized in that the source (5) delivers short light pulses.

9. A method of microscopic visualization of a three-dimensional object according to claim 1, characterized in that optical means form the picture of a thin slice of the object on a matrix detector (6) via the interferometer (2).

10. A device of microscopic visualization of a three-dimensional object comprising
an interferometer (2),
a wide spectrum source (5),
a matrix sensor (6),
means to form the picture of a thin slice of the object on the sensor (6) via the interferometer (2),
a unit for processing the picture produced by the matrix sensor (6),
characterized in that it includes means for inserting local probes (9) in the sample.
